(19) United States
(12) Patent Application Publication
(10) Pub. No.: US 2026/0151945 A1
(43) Pub. Date: Jun. 4, 2026

(54) DRIVE-SYNCHRONIZED METERING CONTROL AND INJECTION MOLDING MACHINE THAT IS OPERATED THEREWITH

(71) Applicant: ARBURG GMBH + CO KG, Lossburg (DE)

(72) Inventor: Thomas RUF, Oberndorf (DE)

(21) Appl. No.: 19/121,694

(22) PCT Filed: Oct. 13, 2023
(86) PCT No.: PCT/EP2023/078489

§ 371 Date: Feb. 19, 2026

(30) Foreign Application Priority Data
Oct. 17, 2022 (DE) 10 2022 127 090.4

(51) Int. Cl. B29C 45/76

(52) U.S. Cl. CPC B29C 45/7613; B29C 2945/76083; B29C 2945/76367; B29C 2945/76545; B29C 2945/76665; B29C 2945/76692; B29C 2945/76846

(57) ABSTRACT

The invention relates to a method for a drive-synchronized metering control in an injection molding unit (1) and to an injection molding unit that is operated according to said method and comprises a temperature-controllable plasticising cylinder (10), which comprises an axial axis and has a material receiving area at one end and a material discharge nozzle (15) at the opposite end and in which a conveyor worm (20) is arranged, said conveyor worm being movable along the axial axis and rotatable about same and having a backflow barrier; a drive (40) for rotating the conveyor worm and a drive (30) for axially moving the conveyor worm; a control unit of the injection molding unit; and means for detecting and storing first and additional process parameters in the control unit. A respective drive (40) for rotating and for axially moving the conveyor worm (20) while taking into consideration at least one respective actual value of the first and additional process parameters are synchronized with each other such that while a metering process is being completed, it is possible to meter a specified metering quantity in a dynamically unadulterated manner and simultaneously stop the two drives.

### REFERENCE TO RELATED APPLICATIONS

The present disclosure relates to and claims priority from German patent application 10 2022 127 090.4, filed on Oct. 17, 2022, the disclosure of which is hereby expressly, in its entirety, made part of the subject matter of the present application.

### TECHNICAL FIELD OF THE

The present disclosure relates to a method for drive-synchronized dosing control in an injection molding machine, to an injection molding machine operated with the method, and to a computer program product that is suitable for performing the method.

The phrase “plasticizable material” as used in this application is to be understood in broad terms, and in addition to plastics or indeed silicone or other thermoplastic and/or elastomeric materials comprises in particular, but not only, for example ceramic, metal and/or powder compositions as well as paper, cellulose, starch, cork, etc. and mixtures of such plasticizable materials. Generally, these may also be materials that have already been previously plasticized, or indeed plastic compositions which, after discharge, cure by themselves or with the use of auxiliaries. The term also comprises recycled materials.

### BACKGROUND

The subject-matter is an injection molding process for processing plasticizable material using an injection molding machine having two movable mold platens and an injection mold that is arranged between the mold platens and has at least one mold cavity. Here, the material is introduced into a temperature-controllable plasticizing cylinder of the injection molding machine, which is preferably movable axially along an injection cylinder axis (main axis) of the injection molding machine, and is then plasticized or melted inside the plasticizing cylinder as a result of rotation of a conveying screw that is movable axially along and around the main axis, as a result of friction and/or temperature control of the plasticizing cylinder.

As a result of rotating the conveying screw in a particular direction of rotation, the plasticized or molten material is conveyed to the tip of the conveying screw and into a dosing chamber within the plasticizing cylinder, wherein the pressure that the conveying screw is to exert on the material is predetermined. During this, a back pressure or dynamic pressure that is adjustable by a controller of the injection molding machine is applied to the conveying screw. As a result of the said rotation and the applied pressure, the conveying screw is moved axially back and is conventionally braked to a standstill (dosing).

The predetermined pressure and the actual dynamic pressure that is exerted on the material are not usually the same, as a result of dynamic and/or geometric dependences (such as material properties, geometries of the plasticizing cylinder and the conveying screw, dynamic pressure, temperature, etc.) in front of the conveying screw. It is known, for the purpose of additional relief of pressure or decompression of the plasticized or molten material, after dosing to move the conveying screw axially back along the main axis and/or to rotate it back, in the opposed direction, around the main axis. Here, first of all process parameters are detected in a parameter detection unit, examples being the screw travel, dynamic pressure, speed of rotation, travel of the conveying screw, travel of the plasticizing cylinder and speed of return of the material as a result of the dynamic pressure. These are stored in a data memory of a controller of the injection molding machine by way of a communication interface. In the event of uncontrolled axial rearward movement and/or rearward rotation, it may happen that, because of the above-mentioned dynamic and/or geometric dependences, the plasticized or molten material results in faulty molded parts (such as overflow or void formation). Thus, this has an adverse effect on the constancy of the weight of the molded part. In the event of purely linear decompression, that is to say retraction of the conveying screw, the weight may be increased, and if the conveying screw is exclusively rotated back the weight may be decreased.

U.S. Pat. No. 5,002,717 A describes a method that controls the injection of a molten resin by an in-line screw-type injection molding machine. The molding machine is equipped with a check ring in order to enable injection of the molten resin by advancing the screw, and also to prevent the molten resin from flowing back. According to the method, the screw is rotated in the normal direction to knead and plasticize a resin material and further to feed the resulting molten resin to the free end portion of the screw. The screw then retracts in order to dose and store a predetermined quantity of the molten resin adjacent to the free end portion of the screw. The screw is next rotated in the opposed direction until the pressure of the molten resin on the rear side of the check ring is lower than that of the molten resin thus dosed and stored on the front side of the check ring. The screw retracts to reduce the pressure of the resin on the front side of the check ring, thereby performing a decompression stroke. Finally, the screw advances to inject the molten resin into a mold. The method for controlling injection through an injection molding machine is intended to enable stable production of molded articles and to always ensure a constant injection quantity of a resin without fluctuations in the dosed resin quantities even if a decompression procedure is performed.

EP 1 465 761 A1 describes a method for controlling the dosing procedure of an injection molding machine and in particular the approach to a dosing position for the screw at the end of the dosing procedure. According to the disclosure, a braking section is determined in a manner dependent on the axial retraction speed of the screw, wherein the axial speed is reduced during the braking section such that the screw reaches an exact end position. For this purpose, the speed of rotation of the screw is varied depending on the current axial retraction speed of the screw. In this way, non-linearities that occur when there is a change to the speed of rotation by comparison with a change in the axial retraction speed can be compensated. The objective is to provide a method for controlling the dosing procedure of an injection molding machine in which a screw end position (dosing position) can always be exactly reached.

DE 10 2020 124 316 A1 discloses a control device and a control method for an injection molding machine, including a cylinder to which a resin is supplied and a screw which moves forward and rearward and rotates within the cylinder. It contains a dosing control unit which, based on predetermined dosing conditions, doses the resin within the cylinder by controlling the forward rotation and rearward movement of the screw until the screw has been moved back into a predetermined dosing position; a detecting unit for the speed of rearward movement, which detects a speed of rearward movement of the screw; a speed determining unit which, based on the speed of rearward movement that is determined during dosing by the detecting unit for the speed of rearward movement, determines a speed of rearward suction in order to cause a resin pressure to reach a target pressure; and a rearward suction control unit, which causes the screw to move further rearward on the basis of the speed of rearward suction after the screw has reached the predetermined dosing position. This is intended to provide a control device and a control method for an injection molding machine, in which the speed of rearward suction can be appropriately and easily determined in order to avoid molding faults within the article to be produced.

DE 10 2020 003 905 A1 discloses an injection molding machine comprising the following: a first drive device, which rotates a screw provided in the interior of a heating cylinder; a second drive device, which moves the screw forward and rearward; a dosing control portion, which is configured to dose resin by controlling the first drive device and the second drive device while the resin is melted, and then to rotate the screw rearward in order thus to reduce the resin pressure; a first sensor unit for detecting the pressure; a second sensor unit for detecting one or more types of physical variables that influence the change in pressure; and a predictor portion, which predicts information on the decompressing rotation, based on the pressure detected by the first sensor unit and the one or more types of physical variables detected by the second sensor unit. The dosing control portion controls the first drive device, based on the information predicted by the predictor portion on the decompressing rotation. The objective is to provide an injection molding machine that optimally reduces the pressure of the molten resin.

WO 2022/102637 A1 discloses a control device for an injection molding machine, having a rearward suction control unit that causes a screw that has reached a predetermined measurement position to be drawn back by suction at a predetermined rearward suction speed. A rearward rotation control unit is provided that causes the screw to be rotated rearwardly on the basis of a predetermined rearward rotation condition value when and after rearward suction begins. A measuring unit measures a value of the rearward rotation condition of the screw. A control unit for ending the rearward suction brings about the end of rearward suction if the condition value of rearward rotation has reached a threshold value.

DE 10 2020 005 573 A1 discloses a control device for an injection molding machine that is equipped with the following: a pressure detecting unit that detects a pressure of a material; a rearward rotation control unit that causes a screw to be rotated to the rear once the screw has reached a predetermined dosing position; a measuring unit that measures elapsed time or an amount of rotation of the screw since the screw has reached a predetermined dosing position; and a control unit for a rearward movement that initiates rearward suction of the screw in a manner overlapping with the rearward rotation of the screw if a predetermined period for initiation of a movement to the rear has elapsed or the screw has been rotated rearwardly by a predetermined amount of rotation for the initiation of a movement to the rear before the screw has reached the predetermined dosing position.

US 2021/178649 A1 discloses a control device for an injection moulding machine comprising a cylinder into which a resin is supplied and a screw that advances and retracts within the cylinder and rotates. The control device comprises a suck-back control unit that sucks back the screw based on a predetermined suck-back speed, suck-back distance or suck-back time period. Furthermore, the control means comprises a pressure detecting unit that detects a pressure of the resin, a calculating unit that calculates a compensation amount of the back-suction speed based on a difference between the pressure of the resin at a time when the back-suction is completed and a predetermined target pressure, and a speed determining unit that redetermines the suck-back speed based on the compensation amount. The metering of the resin is terminated when the screw reaches a certain position, taking into account the pressure on the metered amount of resin. Thereafter, in order to relieve the pressure of the metered resin, the compensation amount of the suck-back speed is calculated taking into account a material parameter, and the pressure relief is carried out by axially displacing the screw. There is no sequential or simultaneous reverse rotation of the screw during the pressure relief.

A control device for controlling an injection screw of an injection moulding machine is known from JP 7 108 157 B1, which comprises a decompression control unit for reducing the pressure of a resin based on a predetermined decompression condition value after the resin has been metered. Further comprising a first measuring unit for measuring the load applied to the screw due to injection of the resin and a second measuring unit for measuring a time from the start of an injection operation by the screw until the load reaches a first threshold value. It also includes a decompression condition correction unit for correcting the predetermined decompression condition value based on a difference between the time and a second threshold value. The metering amount is set based on the screw reaching a certain position, taking into account the pressure on the metered amount of resin. The correction of the decompression condition value is carried out taking into account a material parameter. In this process, at least one value of a return time, a return amount, a return speed, an axial return time, an axial return distance or an axial return speed is adjusted, whereby the screw is simultaneously turned back and axially retracted during the pressure relief of the dosed amount after it has been dosed.

None of the above-mentioned publications satisfactorily solves the problem of producing a homogeneous molded part of constant weight, since either there is sequential retraction of the conveying screw, possibly with subsequent rearward rotation of the conveying screw, or else retraction and rearward rotation of the conveying screw, albeit coordinated, are performed in respect of the dynamic pressure but do not take into account other relevant process parameters.

The first point here is that, before a decompression or pressure relief is executed (regardless of whether this is performed axially or rotationally), the starting conditions when the dosing procedure comes to an end have not been exactly defined, or are not optimal for a definition of bringing to an end. During the dosing procedure, the actual values that are measured, such as torque or dynamic pressure, are subject to a dynamic overlay affected by, among other things, material characteristics (such as dust content, granule shape, material viscosity, material type or material class). For this reason, the values measured by the sensor equipment do not correspond to the data actually present in the plasticized composition, and are also dependent on material characteristics that may be subject to fluctuations.

A further point is the topic of sequential pressure relief as a result of axial and rotational pressure relief. In the known methods, either the pressure is relieved purely axially, or it is relieved by way of rotation, or the combination of both is best described as a sequential execution. This raises the problem that with a purely axial decompression at the end of dosing, the clamped pressure is relieved and so the dosing quantity is passively increased (depending on the previously present dynamic effects and material characteristics, wear on plasticizing components and many other criteria). If a dynamically unfalsified operating point is previously approached, at least the dynamic effects can be eliminated.

This is not sufficient to eliminate the other influencing factors. Once the pressure has been relieved, an increase in the dosed volume can be still be observed. For this reason, even in the unpressurized condition, with axial displacement of the conveying screw the dosed volume is further increased as a result of dynamic/rheological effects.

If, however, the pressure is rotationally relieved, then, as the angle of rotation increases, a smaller and smaller dosed volume is the result. Both effects are dependent on material characteristics and other external factors which are themselves subject to fluctuations and thus impair the constancy of the dosed volume.

### BRIEF SUMMARY

The disclosure provides a method and an injection molding unit, operating by the method, of an injection molding machine, in both of which an axial movement of the conveying screw and a rotational movement thereof are performed in a manner coordinated with one another at the end of the dosing procedure, taking into account the process parameters of relevance thereto, such that a homogeneous molded part of constant weight is producible.

This is a method for drive-synchronized dosing control in an injection molding machine, having a temperature-controllable plasticizing cylinder, to which plasticizable material is supplied and in which it is plasticized and then dosed into a dosing chamber of the plasticizing cylinder, taking into account first process parameters, in particular a dynamic pressure and a speed of return of the material resulting from the dynamic pressure, by axial movement and rotational movement of a conveying screw, wherein the method comprises the following steps:
evaluating the first and further process parameters for the purpose of determining whether a predetermined dosing quantity has been reached in the dosing chamber, and as a result stopping the dosing procedure by bringing the rotation and axial movement of the conveying screw to an end in synchronized manner,
single or multiple decompression of the predetermined dosed quantity in the dosing chamber by simultaneous axial movement of the conveying screw and rotation of the conveying screw at a second setpoint speed of rotation in the second direction until a predetermined or predeterminable position at a target distance of the conveying screw from the material discharge nozzle and/or at a target distance from a previously detected position of the conveying screw is reached,
wherein respectively a drive for rotation and a drive for axial movement of the conveying screw are synchronized to one another, taking into account at least one actual value each of the first and the further process parameters, such that a dosing of the predetermined dosing quantity, independent on dynamic superimpositions of the further process parameters, and simultaneous stopping of both drives at the end of the dosing procedure are performed, wherein stopping of the two drives is initiated depending on the speed of return of the material and is synchronized, either in real time or at the start of the stopping procedure, with setpoint courses of the drives that are determined depending on the actual values, and wherein at least the setpoint curve of one of the two drives is variably adapted.

Advantageously, as a result thereof a homogeneous molded part of constant weight is producible. In particular, the two-stage rearward rotation of the conveying screw during the pressure relief and decompression counteracts an increase in weight in the molded part, while in contrast the simultaneous retraction of the conveying screw counteracts a decrease in weight.

Preferably, the dosing of the predetermined dosing quantity, independent on dynamic superimpositions of the further process parameters, during stopping of the dosing procedure can be achieved particularly well either if the shape of the setpoint curves of the drives is freely selectable, or indeed if both the setpoint curve of the drive for axially moving the conveying screw and the setpoint curve of the drive for rotating the conveying screw are variably adapted.

Pressure relief of the predetermined dosed quantity in the dosing chamber may preferably be performed by simultaneous axial movement of the conveying screw and rotation of the conveying screw at the first setpoint speed of rotation in order in this way to advantageously control pressure relief using both drives.

Preferably, the setpoint courses of the first and further process parameters can be determined from:
mathematical functions,
filtering of step shapes or other signal courses,
limiting of the maximum rate of change of the signal, the first, second and third derivatives.

Thus, corresponding courses may be adapted to constraints such as changing material characteristics, advantageously quickly and using little computing power, from one cycle to the next.

More preferably, the drive for rotation and the drive for axial movement of the conveying screw may be synchronized to one another such that movements of the conveying screw that are executed in synchronized manner are coupled, dependent on one another and/or synchronized to one another. As a result, advantageously a soft target point, at which movements of the conveying screw are brought to an end, may be deliberately achieved at the end of dosing.

In other preferred embodiments of the method, which make it possible to increase even further the accuracy of dosing, the value of the second setpoint speed of rotation is lower than the value of the first setpoint speed of rotation. As an alternative, during rotation at the first setpoint speed of rotation, an axial speed of the conveying screw is set to zero or to a predetermined positive value.

Preferably, the further process parameters comprise at least one material characteristic, such as a granule shape, a dust content of the plasticizable material, a material viscosity, a material type or a material class, in order to advantageously produce a homogeneous molded part of constant weight while taking into account the specific material properties.

Preferably, the further process parameters may however also comprise at least one of the following process parameters: conveyor screw geometry, conveyor screw wear, backflow blocking device geometry. As a result of thus advantageously taking into account the geometric conditions and constraints, the dosing quantity may advantageously be optimized to obtain injection molded parts of constantly high quality.

The disclosure is also achieved by a computer program product. For a rapid, safe and reliable dosing movement, the computer program product is provided with a program code that is stored on a computer-readable medium, for the purpose of performing the method described above by means of the injection molding unit as described above.

The features listed individually in the claims are combinable, where this is technologically meaningful, and may be supplemented by explanatory information from the description and details from the Figures, wherein further variant embodiments of the disclosure are indicated.

The disclosure is now explained in more detail with reference to an exemplary embodiment.

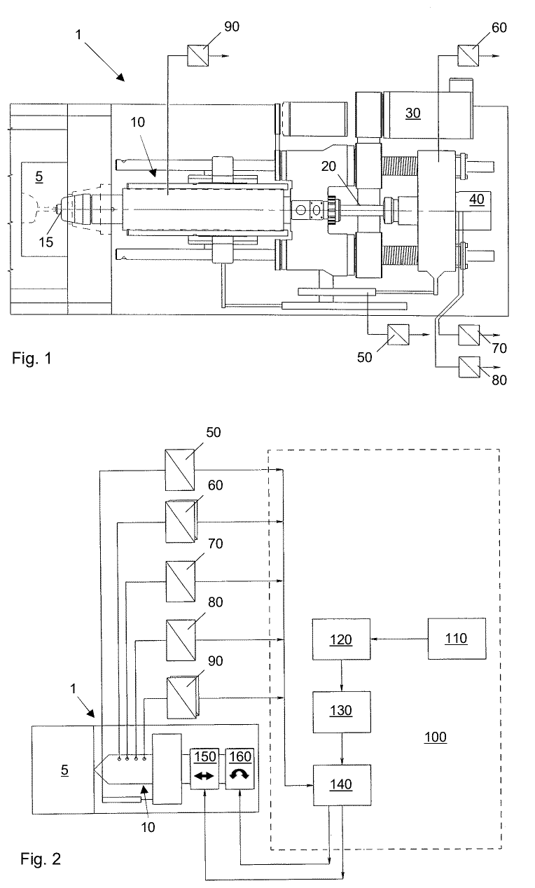

FIG. 1 is an illustration of the plasticizing cylinder and its drives,

FIG. 2 is a schematic block diagram with the plasticizing cylinder and the control unit of the injection molding unit,

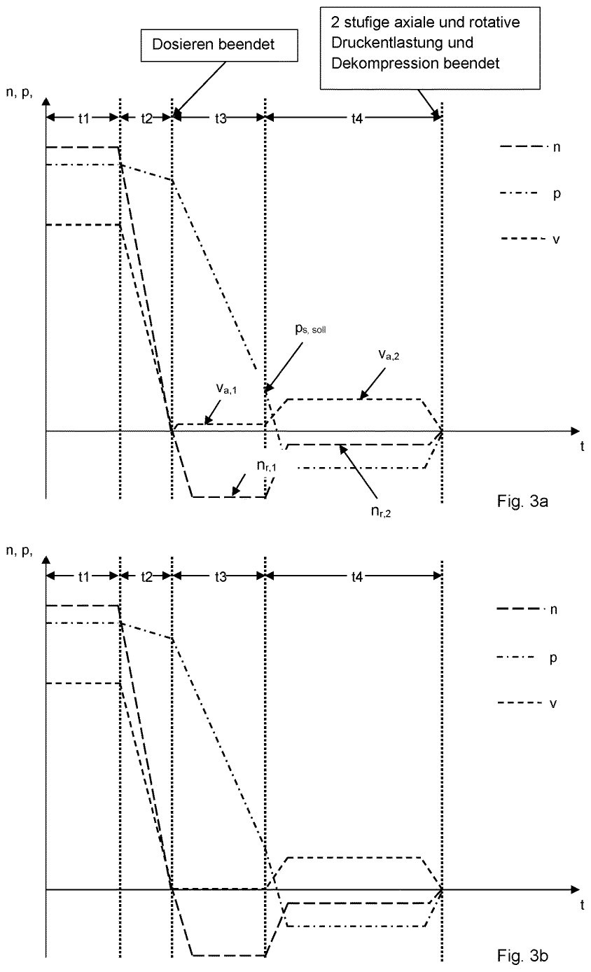

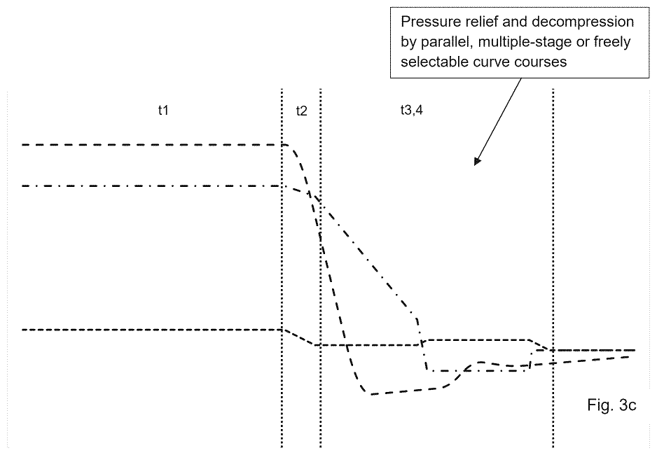

FIGS. 3a-3c show different courses of the linear speed and the speed of rotation of the conveying screw and of the dynamic pressure in the dosing chamber,

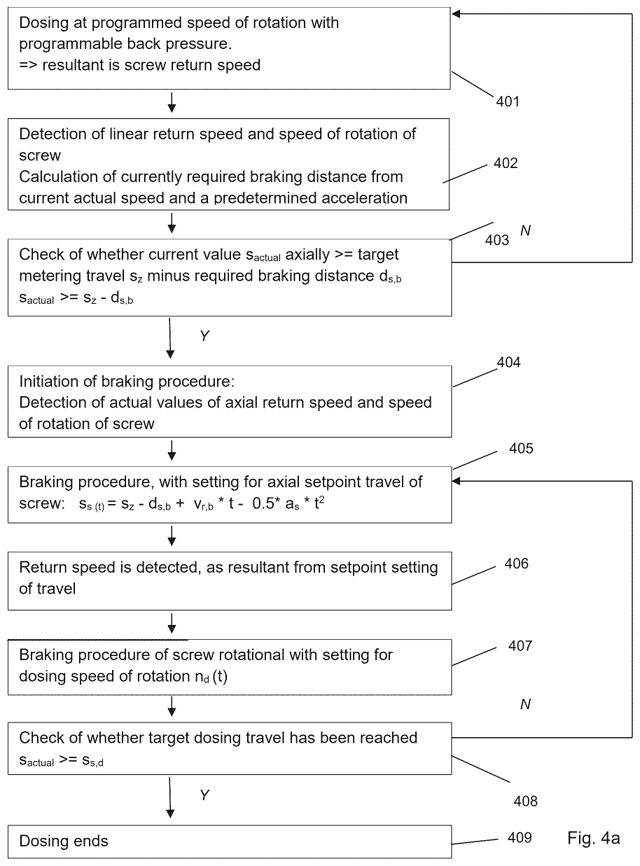

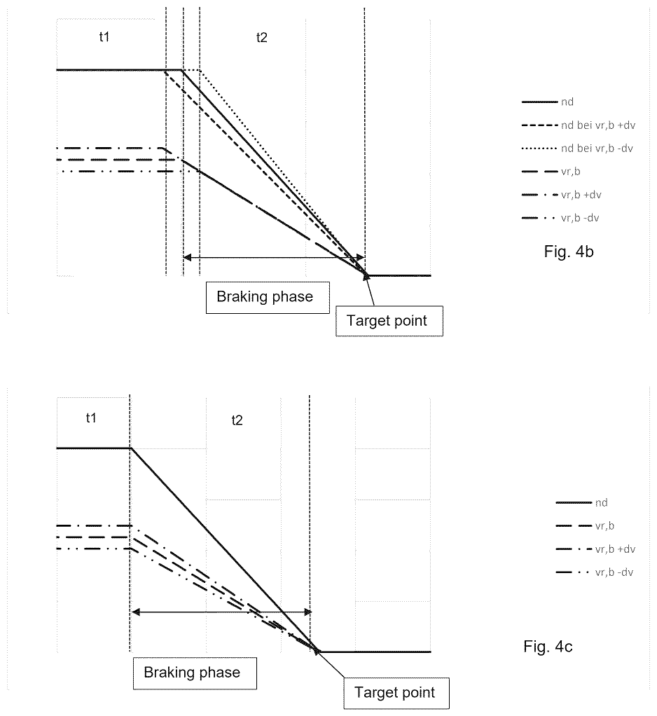

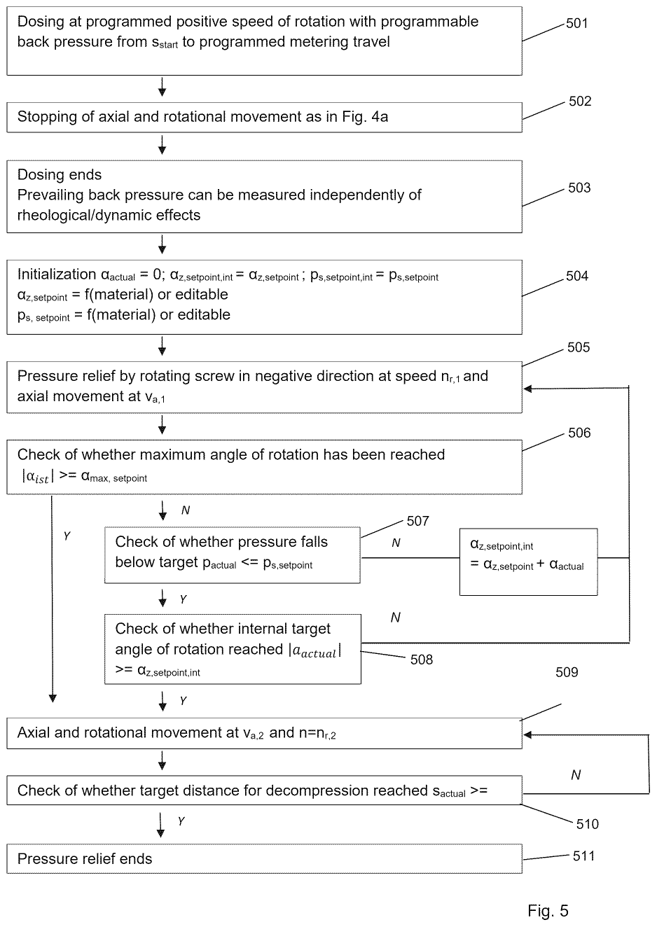

FIG. 4a shows a control sequence according to a first exemplary embodiment,

FIGS. 4b, 4c show the courses of the speed of return and of the braking behavior in the case of the embodiment according to FIG. 4a,

FIG. 5 shows a control sequence according to a second exemplary embodiment, and

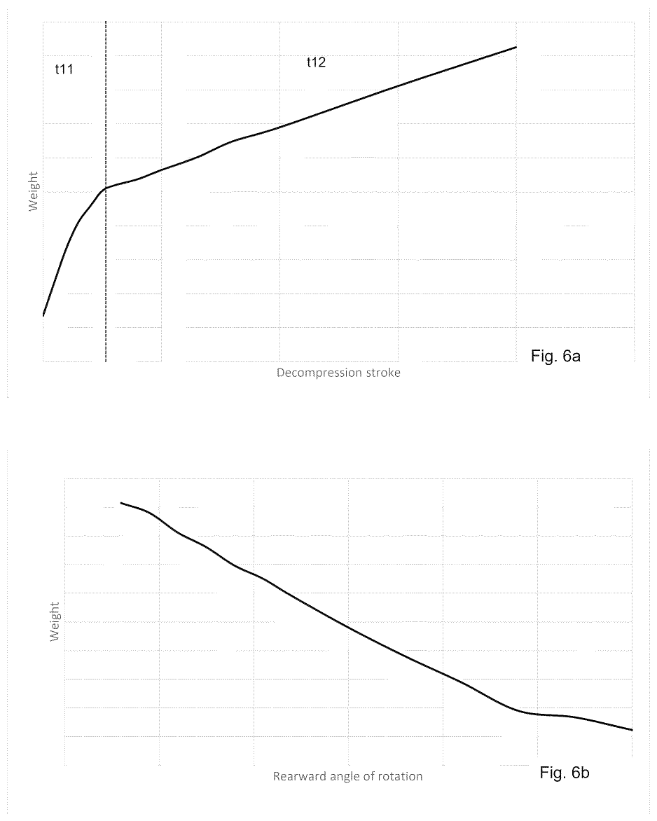

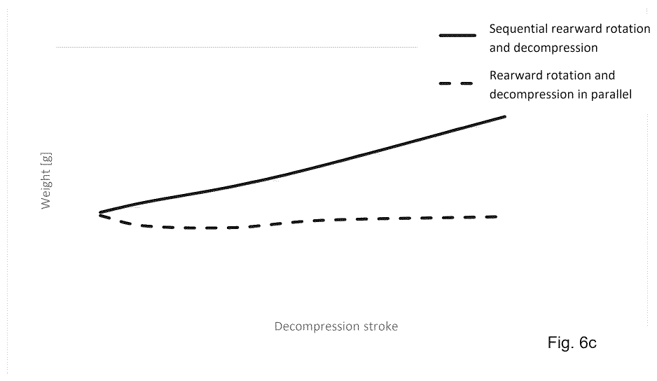

FIGS. 6a-6c show the courses relating to the change in the weight of the molded part over the time of the decompression stroke and/or the rearward angle of rotation.

### DETAILED DESCRIPTION OF PREFERRED EXEMPLARY EMBODIMENTS

The disclosure is now explained in more detail by way of example, with reference to the attached drawings. However, the exemplary embodiments are only examples, which are not intended to restrict the inventive concept to a particular arrangement. Before the disclosure is described in detail it should be pointed out that it is not restricted to the respective structural parts of the device and the respective method steps, since these structural parts and methods may vary. The terms used here are merely intended to describe particular embodiments and are not used restrictively. Moreover, where the singular or the indefinite article is used in the description or the claims, this also refers to a plurality of these elements unless the overall context unambiguously indicates otherwise.

FIG. 1 shows an injection molding unit 1 having an injection mold 5, a plasticizing cylinder 10, a conveying screw 20, a drive 30 for axially moving the conveying screw 20, and a drive 40 for rotating the conveying screw 20. Furthermore, it has a conveying screw absolute position transducer 50 for converting an absolute axial position of the conveying screw into an electrical signal, transducer 60 for converting a speed of rotation or angle of rotation of the conveying screw 20 into electrical signals, a transducer 70 for converting a dynamic pressure in a dosing chamber in front of a free end of the conveying screw 20 into an electrical signal, and a transducer for converting the speed of return of the material as a result of dynamic pressure into an electrical signal. As an alternative, a derivative of the signal from the transducer 50 (travel) may be obtained in order to determine the speed of return.

Moreover, transducers 90 are provided for the purpose of converting additional first process parameters, for example of a plasticizing cylinder travel and of a temperature of the plasticizing cylinder 10 or of the material, which are used in already known methods and injection molding machines having corresponding methods for the purpose of stopping the drives 30, 40. The transducers 90 also serve for converting further process parameters into electrical signals, such as a material viscosity of the plasticizable material, a granule shape and a dust content of the plasticizable material, a conveyor screw geometry, conveying screw wear and a backflow blocking device geometry of a backflow blocking device that is arranged in the vicinity of the free end of the conveying screw.

FIG. 2 shows a schematic block diagram of the injection molding unit 1 with an injection mold 5, a plasticizing cylinder 10, the transducers 50, 60, 70, 80, 90, and a control unit 100. Also illustrated here are a motor controller 150 for the drive 30 for axially moving the conveying screw 20, and a motor controller 160 for the drive 40 for rotating the conveying screw 20. Further illustrated are adjustment device 110 for setting force, speed, speed of rotation, pressure, etc.; storage device 120 for storing values that have been set; device 130 for calculating a setpoint course; and comparator device 140 for comparing actual and setpoint values, wherein these are constituent parts of the control unit 100.

FIGS. 3a and 3b show courses of the setpoint courses of the speed v of axial movement of the conveying screw 20, and the speed of rotation n of the conveying screw, and the resulting dynamic pressure p in the dosing chamber in front of a free end of the conveying screw 20.

In the method for drive-synchronized dosing control in an injection molding machine, an injection molding unit 1 is used with a temperature-controllable plasticizing cylinder 10 having an axial axis, wherein the plasticizing cylinder 10 has a material intake and, in a region at a spacing therefrom, a material discharge nozzle 15, and wherein a conveying screw 20 that is movable along, and rotatable about, the axial axis and has a backflow blocking device is arranged in the plasticizing cylinder 10. The material intake may be provided at one end of the plasticizing cylinder 10, and the material discharge nozzle 15 at an opposing end thereof. Fundamentally, the plasticizing cylinder may be movable axially along a cylinder axis of the injection molding machine in order for example to apply a material discharge nozzle 15 to an injection mold.

The method comprises the following steps:
supplying plasticizable material such as, in particular, granules to the material intake of the plasticizing cylinder 10,
plasticizing the material as a result of rotation of the conveying screw 20 and the resulting frictional heat and/or temperature control of the plasticizing cylinder 10,
conveying the plasticized material into a dosing chamber of the plasticizing cylinder 10 in front of a free end of the conveying screw 20, by rotating the conveying screw 20 in a first direction, wherein a dynamic pressure is formed in the dosing chamber, as a result of which the conveying screw 20 is moved axially away from the material discharge nozzle 15 and a dosing procedure is initiated,
detecting and storing, in a control unit 100 of the injection molding unit 1, first process parameters, in particular a conveying screw absolute position, a speed of rotation of the conveying screw 20, an angle of rotation of the conveying screw 20, a plasticizing cylinder travel, the dynamic pressure, a speed of return of the material as a result of the dynamic pressure, and a temperature of the plasticizing cylinder 10,
detecting and storing and/or providing in the control unit 100 further process parameters, which are dependent on the material to be plasticized,
evaluating the first and further process parameters for the purpose of determining whether a predetermined dosing quantity has been reached in the dosing chamber, and as a result stopping the dosing procedure by bringing the rotation and axial movement of the conveying screw 20 to an end in synchronized manner,
single or multiple relieving of the pressure of the predetermined dosed quantity in the dosing chamber by axial movement of the conveying screw 20 and/or rotation of the conveying screw 20 at a first setpoint speed of rotation in a second direction, opposed to the first direction, until a target angle of rotation of the conveying screw 20 and/or a target dynamic pressure in the dosing chamber is reached, and
single or multiple decompression of the predetermined dosed quantity in the dosing chamber by simultaneous axial movement of the conveying screw 20 and rotation of the conveying screw 20 at a second setpoint speed of rotation in the second direction until a predetermined or predeterminable position at a target distance of the conveying screw 20 from the material discharge nozzle 15 and/or at a target distance from a previously detected position of the conveying screw is reached,
wherein respectively a drive 40 for rotation and a drive 30 for axial movement of the conveying screw are synchronized to one another, taking into account at least one actual value each of the first and the further process parameters, such that a dosing of the predetermined dosing quantity, independent on dynamic superimpositions of the further process parameters, and simultaneous stopping of both drives 30, 40 at the end of the dosing procedure are performed, wherein stopping of the two drives 30, 40 is initiated depending on the speed of return of the material and is synchronized, either in real time or at the start of the stopping procedure, with setpoint courses of the drives 30, 40 that are determined depending on the actual values, and wherein at least the setpoint curve of one of the two drives 30, 40 is variably adapted.

In a preferred embodiment, the pressure of the predetermined dosed quantity in the dosing chamber may be relieved by simultaneous axial movement of the conveying screw 20 and rotation of the conveying screw 20 at the first setpoint speed of rotation. Generally, however, it is also possible to perform simultaneous stopping of both drives if, when halting, a drive is already in a halt condition at this point in time.

First of all, the plasticizable material, in particular in the form of granules, is thus supplied to the material intake of the plasticizing cylinder 10. Then, the material is plasticized as a result of the conveying screw 20 rotating in a first direction and the frictional heat produced and/or temperature control of the plasticizing cylinder 10, and during the period t1 is moved in front of a free end of the conveying screw 20 and into a dosing chamber of the plasticizing cylinder 10. During this, a dynamic pressure builds up in the dosing chamber, as a result of which the conveying screw 20 is moved axially back. The plasticized material may be conveyed into the dosing chamber with a predetermined speed of rotation and a predetermined dosing travel.

As the first process parameters there is detected for example at least one process parameter, comprising a conveying screw absolute position, a speed of rotation of the conveying screw 20, an angle of rotation of the conveying screw 20, a travel of the conveying screw 20, a dynamic pressure, a speed of return of the material as a result of the dynamic pressure, or a temperature of the plasticizing cylinder 10, and these are stored in a control unit 100 of the injection molding unit 1.

As further process parameters there are detected parameters in a manner dependent on the material such as a granule shape or a dust content of the plasticizable material, a material viscosity, a material type, a material class, and are stored in the control unit 100. Further process parameters may also be a conveying screw geometry, conveying screw wear, or backflow blocking device geometry, which are detected and stored in the control unit 100.

Then, the first and further process parameters are evaluated for the purpose of determining whether a predetermined dosing quantity has been reached in the dosing chamber, and as a result of this a drive 30 for axial movement of the conveying screw 20 and a drive 40 for rotation of the conveying screw 20 are stopped in synchronized manner for the period t2, for the purpose of stopping the dosing procedure.

At the end of dosing, after the period t2, the conveying screw 20 is rotated in a direction which is opposed to the first direction at a first speed of rotation during the period t3, for the purpose of relieving the pressure or decompressing the material in the dosing chamber, wherein the axial speed of the conveying screw 20 is synchronized to this. During the period t4, decompression of the material in the dosing chamber is continued, wherein the conveying screw 20 is rotated further at a second speed of rotation, and the axial speed of the conveying screw 20 is synchronized to this. During pressure relief or decompression, in each case the axial speed of the conveying screw 20 is synchronized to the speed of rotation of the conveying screw 20 such that within the dosed quantity no dynamic falsifications that would result in later overflow or void formation within the molded part to be produced occur.

In a further embodiment, the setpoint speed of rotation of the conveying screw 20 may likewise be synchronized to the axial speed of the conveying screw. Thus, rearward rotation at different speeds and adaptation of the axial speed of the conveying screw 20 during pressure relief or decompression is performed in at least two stages. Fundamentally, more than two stages may also be provided, wherein where necessary the speed of rotation may be lowered or indeed raised from one step to the next.

The terms “single or multiple relieving of pressure” of the predetermined dosed quantity in the dosing chamber and “single or multiple decompression” of the predetermined dosed quantity in the dosing chamber are understood to mean for example axial movements and rotational movement, in single or multiple stages or executed in parallel, not only in steps but also by way of freely selectable curve courses that may be controlled as a setpoint value.

Here, the setpoint courses may be determined from:
mathematical functions,
filtering of step shapes or other signal courses,
limiting of the maximum rate of change of the signal, the first, second and third derivatives.

The term “target distance of the conveying screw 20 from the material discharge nozzle 15” is understood to mean a particular geometrical spacing that is calculated as a target setting and to which the value is set by control. Fundamentally, however, a target setting of this kind may also be achieved in that positions relative to the previously approached positions are determined for example once the synchronized bringing to an end of dosing is at an end. The variables of target dynamic pressure, target angle, target angle of rotation and target distance may thus, as an alternative, also be determined relative to the previously detected actual values of pressure, angle and distance.

The method may be implemented in an injection molding unit 1 of an injection molding machine having a temperature-controllable plasticizing cylinder 10 which has an axial axis and a material intake and, at a spacing therefrom, a material discharge nozzle 15, and in which is arranged a conveying screw 20 that is movable along and rotatable about the axial axis and has a backflow blocking device. It further comprises a drive 40 for rotation and a drive 30 for axial movement of the conveying screw 20, a control unit 100 of the injection molding unit 1, and devices for detecting and storing first and further process parameters in the control unit 100.

As a result of synchronizing the drives 30, 40 in respect of the speed of rotation and the axial speed of the conveying screw 20 respectively during stopping of dosing, dependence of the dosed volume (shot weight) on the speed of rotation of the conveying screw 20 is dramatically reduced. Furthermore, dynamic and/or geometric dependences are eliminated, as a result of which it becomes possible during dosing to correct a dynamic pressure fault in real time and to determine the actual dynamic pressure. As a result, it also becomes possible to markedly reduce a difference in dosed volume between two differently parameterized injection molding units 1.

Preferably, the dosing of the predetermined dosing quantity, independent on dynamic superimpositions of the further process parameters, can be achieved during stopping of the dosing procedure either, particularly well, in that the shapes of the setpoint courses of the drives 30, 40 are freely selectable, or indeed in that both the setpoint curve of the drive 30 for axially moving the conveying screw 20 and also the setpoint curve of the drive 40 for rotating the conveying screw 20 are variably adapted.

In the prior art, during the dosing procedure the measured actual values, such as torque or dynamic pressure, are subject to a dynamic overlay affected by, among other things, material characteristics (such as dust content, granule shape, material viscosity, material type or material class). For this reason, the values measured by the sensor equipment do not correspond to the data actually present in the plasticized composition, and are also dependent on material characteristics that may be subject to fluctuations. For this reason, before decompression or pressure relief of whatever kind is performed, a defined operating point has to be reached at the end of the dosing procedure in order to obtain measured values, independent on dynamic superimpositions of the further process parameters.

Taking this as a starting point, the measured values give significantly better information and may be used for subsequent control.

A further point is the topic of sequential pressure relief as a result of axial and rotational pressure relief, in contrast to parallel pressure relief. In the known methods, either the pressure is relieved purely axially, or it is relieved by way of rotation, or the combination of both is best described as a sequential execution. This has the effect that with a purely axial decompression at the end of dosing, the clamped pressure is relieved and so the dosing quantity is passively increased (depending on the previously present dynamic effects and material characteristics, wear on plasticizing components and many other criteria) (time segment t11 in FIG. 6a). If an operating point, independent on dynamic superimpositions of the further process parameters, is previously approached, at least the dynamic effects can be eliminated.

This is not sufficient to eliminate the other influencing factors. Once the pressure has been relieved, an increase in the dosed volume can still be observed (time segment t12 in FIG. 6a). For this reason, even in the unpressurized condition, with axial displacement of the conveying screw 20 the dosed volume is further increased as a result of dynamic/rheological effects.

If, however, the pressure is rotationally relieved, then, as the angle of rotation increases, a smaller and smaller dosed volume is the result. This effect is also dependent on material characteristics (see FIG. 6b).

Both effects are dependent on material characteristics and other external factors which are themselves subject to fluctuations and thus impair the constancy of the dosed volume.

For this reason, according to the disclosure axial and rotational movement are combined, with the objective of neither increasing nor decreasing the dosed volume during decompression or pressure relief. This is only possible as a result of a mutually coordinated movement of the conveying screw 20 rotationally and axially in parallel. Furthermore, parallel operation of the two movements makes it possible to make a time saving.

This is discernible in FIG. 6c, in which a comparison can be seen between sequential execution of pressure relief by rotation and subsequent axial decompression, and pressure relief and decompression in which the axial and rotational movement were performed at least in part simultaneously. Although with sequential execution the increase in volume is no longer as dramatic as in FIG. 6a, the increase in weight is still present as a result of longer decompression strokes. This can be avoided by suitable executions in parallel.

In a further variant of the method, the segments t3 and t4 in FIGS. 3a, 3c can be replaced by a plurality of segments of a freely selectable number n, or by freely selectable courses of curves of the speed of rotation and the axial speed of the conveying screw (FIG. 3c). Likewise, it is possible for one parameter to take a curve shape and for the other to take a plurality of steps, or vice versa. Here, the start of the steps may also be dependent on the other signal with a freely selectable curve course.

Here, the curve courses may for example be generated using mathematical functions, filtering of step courses or polygonal shapes that are available, limiting of the maximum rate of change of the signal, the first, second and third derivatives.

FIG. 4a describes a control sequence of time segments t1 and t2 in FIG. 3a and FIG. 3b. At step 401 in FIG. 4a, during the dosing procedure the speed of rotation of the conveying screw and the dynamic pressure that has built up are controlled. The return speed produced from this is a resultant depending on material behavior, screw wear, screw geometry and other parameters (see FIG. 4a and FIG. 4b).

At step 402 in FIG. 4a, the return speed of the conveying screw 20 during dosing is continuously detected. Likewise, during dosing the currently produced braking distance resulting from the actual speed and a predetermined acceleration are continuously calculated. In a further variant, in step 402 the braking time produced can also be calculated from the prevailing actual speed of rotation of the conveying screw 20 and a predetermined angular acceleration. At the same time, a switch-off time is calculated from the current actual speed. From this switch-off time and the current linear speed it is likewise again possible to calculate the braking distance produced.

In step 403, a check is performed of whether the current actual value s_{actual} is axially greater or equal to the target dosing travel s_{z} minus the calculated braking distance d_{s,b}. If this condition is met, the braking phase in step 404 is initiated. If this condition is not met, there is a jump back to step 401.

In step 404, for the purpose of initiating the braking procedure, the current actual values of the axial return speed and the speed of rotation of the conveying screw 20 at the starting point of the time for braking are then detected.

In step 405, the braking procedure is initiated with the setting for a setpoint position sₛ₍ₜ₎ of the conveying screw 20 calculated from target dosing travel s_{z} minus the calculated braking distance d_{s,b} plus the detected return speed v_{r,b} of the conveying screw, multiplied by the time t minus the linear setpoint acceleration aₛ multiplied by the time t² from initiation of the braking procedure squared and divided by 2:

$${s}_{s ( t )} = {s}_{z} - {ds}_{brake} + {v}_{r} * t - 0.5 * {a}_{s} * {t}^{2}$$

In step 406, the axial return speed is detected, resulting from the setpoint setting from step 405.

In step 407, the setpoint setting for the dosing speed of rotation n_{d}(t) is calculated from the actual value of the axial return speed vᵣ divided by the axial return speed when the braking procedure is initiated v_{r,B} multiplied by the speed of rotation of the conveying screw 20 when the braking procedure is initiated n_{d,B}:

$${n}_{d} ( t ) = {v}_{r ,} / {v}_{r , B} * {n}_{d , B}$$

In a further variant of the method, the steps 404 to 407 may also be performed recursively, such that for calculation of the setpoint position on each control pulse newly detected actual values of the axial return speed and the speed of rotation are detected, and the time step then corresponds to the controller pulse.

In step 408, a check is performed of whether the current axial actual travel s_{actual} of the conveying screw 20 is greater than or equal to the target dosing travel s_{s,d}. If this condition is met, the procedure of dosing is also brought to an end (step 409). In the above-mentioned recursively calculated variant of steps 404 to 407, there would be a jump here back to step 404 if the check gave a negative result.

FIG. 4b illustrates how differently resulting axial return speeds affect braking behavior. Illustrated here is the behavior that results if the resulting axial return speed of the screw (v_{r,b}) varies by plus dv or minus dv (v_{,rb+dv}, v_{,rb-dv}). From this results the associated behavior of the speed of rotation of the rotational drive, produced in the standard case (nd) and/or in the cases where dv is higher (n_{d} when v_{r,b+dv}) or lower (n_{d} when v_{r,b-dv}) than the axial return speed. Here, depending on the axial return speed, the braking behavior of the axis of rotation is altered such that both axes come to a standstill simultaneously.

FIG. 4c illustrates a further variant, in which the braking behavior is adapted to the axial movement such that with different return speeds both the linear axis and the axis of rotation come to a standstill simultaneously. The linear braking behaviors illustrated in FIG. 4b and FIG. 4c are an exemplary embodiment. It may likewise take any conceivable nonlinear form.

FIG. 5 describes a variant of the control sequence, relating to the time segment t3+t4 in FIGS. 3a, 3b and 3c. At step 501 of FIG. 5a is the dosing procedure of an injection molding machine (time segment t1). At step 502 is the braking procedure, described above in FIG. 4a, during the time segment t2. At step 503 is the point in time at which dosing comes to an end.

As a result of the previously achieved targeted synchronization of both the axial movement and the rotational movement of the conveying screw 20, from this point in time it is possible to measure the pressures of the material in front of the screw and/or other physical measurement variables, independently of rheological/dynamic effects. This forms the basis for precise pressure relief and decompression.

At step 504 is the point in time at which pressure relief and decompression are initiated. Here, the currently prevailing angular position of the conveying screw 20 is measured with the aid of the measuring device 60 and stored as a zero or reference position (α_{actual}=0). An internal setpoint value α_{z,setpoint,int} is also formed. This internal setpoint value is formed from the editable additional angle α_{z,setpoint}. Likewise, the internal setpoint value p_{s,setpoint,int} of a pressure is formed from the editable setpoint value p_{s,setpoint}.

$${α}_{z , setpoint , i n t} = {α}_{z , setpoint}$$

$${p}_{s , setpoint , i n t} = {p}_{s , setpoint}$$

In a further variant of FIG. 5, in step 504 the internal setpoint values a_{z,setpoint} and p_{s,setpoint} may be a function of at least one material characteristic. Material characteristics are for example a granule shape, a dust content of the plasticizable material, a material viscosity, a material type or a material class.

Both values may also take the value 0 independently of one another. Likewise, it is also possible for in each case only one of the two values a_{z,setpoint} and p_{s,setpoint} to be active and the other inactive. For this reason, in an exemplary embodiment, the pressure p_{s,setpoint} may be inactive and the angle a_{z,setpoint} active and dependent on a material characteristic.

Steps 505 to 508 describe the time segment t3 from FIGS. 3a to 3b. At step 505 is the configuration of the segment pressure relief with parallel axial movement of the conveying screw 20 at axial speed v_{a,1} and rotational movement n_{r,1}. The values v_{a,1} and n_{r,1} may in this case be formed by constant values or entire profiles, or indeed by freely selectable curve shapes using mathematical functions. The courses of the two parameters speed of rotation and axial speed of the conveying screw 20 may be independent of one another or indeed dependent on one another, n=f(v) or v=(f)n. Both values may also take the value 0 independently of one another.

In a further variant, the values v_{a,1} and n_{r,1} may be calculated from measured values in the time segments t1 and/or t2. A further variant of step 505 determines the magnitude, function and/or mutual dependence of v_{a,1} and n_{r,1} from engineering data or from rheological, thermal and/or fluid-mechanical calculations derivable from these.

In step 506, a check is performed of whether the magnitude of the current actual angle of rotation α_{actual} is greater than or equal to a previously predetermined maximum angle of rotation α_{max,setpoint}. α_{max,setpoint} may be editable, calculated by statistical evaluation, or indeed may be dependent on a material characteristic.

$$\vert {a}_{actual} \vert >= {α}_{m ax , setpoint}$$

If the condition in step 506 is met, the sequence progresses to step 509. If it is not met, a check is performed in step 507 of whether the currently measured actual pressure p_{actual} is less than or equal to the predetermined target pressure p_{r,setpoint} from step 504. If this condition is not met, the internal target angle of rotation α_{z,setpoint,int} is formed again by adding the setpoint value α_{z,setpoint} to the currently measured angle of rotation α_{actual}. Then there is a jump back to step 505 again.

If the condition is met, the sequence progresses to step 508. In step 508, a check is performed of whether the magnitude of the current actual angle of rotation α_{actual} is greater than or equal to the internal target angle of rotation α_{z,setpoint,int}. If the condition is not met, there is a jump back to step 505 again. If the condition is met, the sequence progresses to step 509.

Steps 509 and 510 describe the time segment t4 in FIGS. 3a and 3b. At step 509 is the configuration of the segment pressure relief with parallel axial movement of the conveying screw 20 with v_{a,2} and rotational movement n_{r,2}. The values v_{a,2} and n_{r,2} may be formed by constant values or entire profiles, or indeed by freely selectable curve shapes using mathematical functions. The courses of the two parameters speed of rotation and axial speed of the conveying screw may be independent of one another or indeed dependent on one another, n=f(v) or v=(f)n. Both values may also take the value 0 independently of one another. In a further variant, the values v_{a,2} and n_{r,2} may be calculated from measured values in the time segments t1, t2 and/or t3.

A further variant of step 509 determines the magnitude, function or mutual dependence of v_{a,2} and n_{r,2} from engineering data or from rheological, thermal and/or fluid-mechanical calculations derivable from these.

In step 510, a check is performed of whether the current axial actual travel of the conveying screw is greater than or equal to the target distance for decompression s_{s,de}. The target distance for decompression s_{s,de} may be editable, dependent on structural features of the conveying screw 20 and other plasticizing components, or calculated depending on other process parameters.

If this condition is met, the execution of pressure relief (t3+t4 in FIGS. 3a and 3b) comes to an end at step 511. If the condition is not met, there is a return to step 509 again.

FIG. 6a shows the consequently dosed volume which, after decompression, is present in front of the screw in the case of purely axial decompression. The volume increases as the stroke becomes longer, with two segments being discernible. The material characteristics, process parameters that are applied, and dynamic influences result in these segments being pronounced to different extents. In segment t11, the volume increases dramatically by comparison with the stroke, because the pressure prevailing in the screw turns is being relieved here. Then, in segment t12, the volume continues to increase as a result of dynamic/rheological effects.

FIG. 6b shows the dosed volume plotted over a rearward angle of rotation with pressure relief as a result purely of rearward rotation. Here too, the extent to which the course is pronounced depends on material characteristics, albeit the trend is always toward smaller volumes as the rearward angle of rotation increases.

FIG. 6c shows a comparison between a sequential combination of rearward rotation and axial decompression, and execution with rearward rotation and axial movement performed in a similar manner and parallel to one another. Here, it can be seen that the increase in the dosed volume in the sequential combination is no longer as pronounced as in FIG. 6a, although it is always clearly present. By contrast, with a suitable parallel execution, the dosed volume can be kept at an approximately constant level.

In other preferred embodiments of the method which make it possible to increase the accuracy of dosing even further, the value of the second setpoint speed of rotation is lower than the value of the first setpoint speed of rotation (FIGS. 3a, 3b). As an alternative, an axial speed of the conveying screw 20 during rotation at the first setpoint speed is set to zero (FIG. 3b) or to a predetermined positive value (FIG. 3a).

An injection molding unit 1 of a machine for processing plastics and other plasticizable materials may be configured such that it can perform the method. It has a temperature-controllable plasticizing cylinder 10 which has an axial axis and, at one end, a material intake configured for supplying plasticizable material, and at an end opposed to this a material discharge nozzle 15. Arranged in the plasticizing cylinder 10 is a conveying screw 20 that is movable along and rotatable about the axial axis and has a backflow blocking device. A drive for rotating the conveying screw 20 is provided in the plasticizing cylinder 10 and configured to plasticize material, as a result of rotation of the conveying screw 20 and the resulting frictional heat and/or by temperature control of the plasticizing cylinder 10, and to convey plasticized material into a dosing chamber of the plasticizing cylinder 10 in front of a free end of the conveying screw 20 by rotating the conveying screw 20 in a first direction, wherein a dynamic pressure is formed in the dosing chamber, as a result of which the conveying screw 20 moves axially away from the material discharge nozzle 15 and a dosing procedure is initiated. A drive 30 is provided for axially moving the conveying screw 20. The injection molding unit further has a control unit 100, and devices for detecting and storing first and further process parameters in the control unit 100.

Devices for detecting and storing further process parameters and/or devices for providing further process parameters in the control unit 100 are provided, wherein the further process parameters are dependent at least also on the material to be plasticized. An evaluating unit is provided and is configured to evaluate the first and further process parameters for the purpose of determining whether a predetermined dosing quantity has been reached in the dosing chamber and, when the predetermined dosing quantity has been reached, outputting a signal to the control unit 100. The control unit 100 is configured, by way of control devices for controlling the drives 30, 40, to stop the dosing procedure as a result of bringing rotation of the conveying screw 20 and axial movement of the conveying screw 20 to an end in synchronized manner.

Pressure relief devices are provided, and these are configured for single or multiple pressure relief of the predetermined dosed quantity in the dosing chamber as a result of axial movement of the conveying screw 20 and/or rotation of the conveying screw 20 at a first setpoint speed of rotation in a second direction, opposed to the first direction, until a target angle of rotation of the conveying screw 20 and/or a target dynamic pressure in the dosing chamber is reached.

Decompression devices are provided, and these are configured for single or multiple decompression of the predetermined dosed quantity in the dosing chamber by preferably simultaneous axial movement of the conveying screw 20 and rotation of the conveying screw 20 at a second setpoint speed of rotation in the second direction until a predetermined or predeterminable position at a target distance of the conveying screw 20 from the material discharge nozzle 15 and/or at a target distance from a previously detected position of the conveying screw 20 is reached. Here, respectively a drive 40 for rotation and a drive 30 for axial movement of the conveying screw 20 are synchronized to one another, taking into account in each case at least one actual value of the first and the further process parameters, such that a dosing, independent on dynamic superimpositions of the further process parameters, of the predetermined dosing quantity and stopping of both drives 30, 40 at the end of the dosing procedure are performed, wherein stopping of the two drives 30, 40 is initiated depending on the speed of return of the material and is synchronized, either in real time or at the start of the stopping procedure, with setpoint courses of the drives 30, 40 that are determined from the actual values, and wherein at least the setpoint curve of one of the two drives 30, 40 is variably adapted.

A computer program product having a program code that is stored on a computer-readable medium may be used for performing the method in that it preferably generates control commands for the control unit and/or the parts of the machine on the basis of the program code.

It goes without saying that this description may be subject to the most diverse modifications, changes and adaptations which are within the range of equivalents to the attached claims.

1.-12. (canceled)

13. A method for drive-synchronized dosing control of an injection molding unit of a machine for processing plastics and other plasticizable materials, comprising a temperature-controllable plasticizing cylinder which has an axial axis and which has a material intake and, in a region at a spacing therefrom, a material discharge nozzle, and arranged in which is a conveying screw that is movable along and rotatable about the axial axis and comprises a backflow blocking device,
wherein the method comprises the following steps:
supplying plasticizable material to the material intake of the plasticizing cylinder,
plasticizing the material to a plasticized material as a result of rotating the conveying screw and at least one of a resulting frictional heat or a temperature control of the plasticizing cylinder,
conveying the plasticized material into a dosing chamber of the plasticizing cylinder in front of a free end of the conveying screw by rotating the conveying screw in a first direction, wherein a dynamic pressure is formed in the dosing chamber, as a result of which the conveying screw is moved axially away from the material discharge nozzle and a dosing procedure is initiated,
detecting and storing, in a control unit of the injection molding unit, first process parameters of the injection molding unit,
at least one of detecting and storing or providing in the control unit further process parameters, which are dependent on the material to be plasticized,
single or multiple pressure relief of a predetermined dosed quantity in the dosing chamber as a result of at least one of an axial movement of the conveying screw or a rotation of the conveying screw at a first setpoint speed of rotation in a second direction, opposed to the first direction, until at least one of a target angle of rotation of the conveying screw or a target dynamic pressure in the dosing chamber is reached,
wherein the method comprises:
evaluating the first process parameters and the further process parameters for determining whether the predetermined dosed quantity has been reached in the dosing chamber, and as a result stopping the dosing procedure by bringing the rotation of the conveying screw and the axial movement of the conveying screw to an end of the dosing procedure in synchronized manner, and
single or multiple decompression of the predetermined dosed quantity in the dosing chamber by simultaneous axial movement of the conveying screw and rotation of the conveying screw at a second setpoint speed of rotation in the second direction until at least one of a predetermined or predeterminable position at a target distance of the conveying screw from the material discharge nozzle or at a target distance from a previously detected position of the conveying screw is reached,
wherein a drive for rotation and a drive for axial movement of the conveying screw are synchronized to one another, taking into account at least one actual value each of the first and the further process parameters, such that a dosing of the predetermined dosed quantity, independent on dynamic superimpositions of the further process parameters, and simultaneous stopping of both drives at the end of the dosing procedure are performed, wherein the stopping of the two drives is initiated depending on the speed of return of the material and is synchronized, either in real time or at the start of the stopping procedure, with setpoint courses of the drives that are determined depending on the actual values, and wherein at least the setpoint curve of one of the two drives is variably adapted.

14. The method as claimed in claim 13, wherein a shape of the setpoint courses of the drives is freely selectable.

15. The method as claimed in claim 13, wherein both the setpoint curve of the drive for the axial movement the conveying screw and the setpoint curve of the drive for the rotation of the conveying screw are variably adapted.

16. The method as claimed in claim 13, wherein the pressure relief of the predetermined dosed quantity in the dosing chamber is performed by simultaneous axial movement of the conveying screw and rotation of the conveying screw at the first setpoint speed of rotation.

17. The method as claimed in claim 13, wherein the setpoint courses of the first and further process parameters are determined from:
mathematical functions,
filtering of step shapes or other signal courses,
limiting of the maximum rate of change of the signal, the first, second and third derivatives.

18. The method as claimed in claim 13, wherein the drive for rotation and the drive for axial movement of the conveying screw are synchronized to one another such that movements of the conveying screw that are executed in synchronized manner are coupled, such that they are at least one of dependent on one another or synchronized to one another.

19. The method as claimed in claim 13, wherein the value of the second setpoint speed of rotation is lower than the value of the first setpoint speed of rotation.

20. The method as claimed claim 13, wherein, during rotation at the first setpoint speed of rotation, an axial speed of the conveying screw is set to zero or to a predetermined positive value.

21. The method as claimed in claim 13, wherein the further process parameters comprise at least one material characteristic selected from the group comprising a material type, a material class, a granule shape, a dust content of the plasticizable material, or a material viscosity.

22. The method as claimed in claim 13, wherein the first process parameters comprise at least one of the following process parameters: a conveying screw absolute position, a speed of rotation of the conveying screw, an angle of rotation of the conveying screw, a plasticizing cylinder travel, the dynamic pressure, a speed of return of the material as a result of the dynamic pressure, or a temperature of the plasticizing cylinder.

23. The method as claimed in claim 13, wherein the further process parameters comprise at least one of the following process parameters: conveyor screw geometry, conveyor screw wear, backflow blocking device geometry.

24. An injection molding unit of a machine for processing plastics and other plasticizable materials, comprising:
a temperature-controllable plasticizing cylinder comprising an axial axis and, at one end, a material intake configured for supplying plasticizable material, and at an end opposed thereto a material discharge nozzle,
arranged in the plasticizing cylinder, a conveying screw that is movable along and rotatable about the axial axis and has a backflow blocking device,
a drive for rotation of the conveying screw in the plasticizing cylinder configured to plasticize material by rotating the conveying screw and at least one of the resulting frictional heat or by temperature control of the plasticizing cylinder and to convey plasticized material into a dosing chamber of the plasticizing cylinder in front of a free end of the conveying screw by rotating the conveying screw in a first direction, wherein a dynamic pressure is formed in the dosing chamber, by which the conveying screw is moved axially away from the material discharge nozzle and a dosing procedure is initiated,
a drive for axial movement of the conveying screw,
a control unit of the injection molding unit, and
devices for detecting and storing first and further process parameters in the control unit,
wherein the injection molding unit is configured to perform the method as claimed in claim 1.

25. A computer program product having a program code that is stored on a computer-readable medium, comprising instructions which cause the injection molding unit according to claim 24 to carry out a method for drive-synchronized dosing control of the injection molding unit, the method comprising:
supplying plasticizable material to the material intake of the plasticizing cylinder,
plasticizing the material to a plasticized material as a result of rotating the conveying screw and at least one of a resulting frictional heat or a temperature control of the plasticizing cylinder,
conveying the plasticized material into a dosing chamber of the plasticizing cylinder in front of a free end of the conveying screw by rotating the conveying screw in a first direction, wherein a dynamic pressure is formed in the dosing chamber, as a result of which the conveying screw is moved axially away from the material discharge nozzle and a dosing procedure is initiated,
detecting and storing, in a control unit of the injection molding unit, first process parameters of the injection molding unit,
at least one of detecting and storing or providing in the control unit further process parameters, which are dependent on the material to be plasticized,
single or multiple pressure relief of a predetermined dosed quantity in the dosing chamber as a result of at least one of an axial movement of the conveying screw or a rotation of the conveying screw at a first setpoint speed of rotation in a second direction, opposed to the first direction, until at least one of a target angle of rotation of the conveying screw or a target dynamic pressure in the dosing chamber is reached,
wherein the method comprises:
evaluating the first process parameters and the further process parameters for determining whether the predetermined dosed quantity has been reached in the dosing chamber, and as a result stopping the dosing procedure by bringing the rotation of the conveying screw and the axial movement of the conveying screw to an end of the dosing procedure in synchronized manner, and
single or multiple decompression of the predetermined dosed quantity in the dosing chamber by simultaneous axial movement of the conveying screw and rotation of the conveying screw at a second setpoint speed of rotation in the second direction until at least one of a predetermined or predeterminable position at a target distance of the conveying screw from the material discharge nozzle or at a target distance from a previously detected position of the conveying screw is reached,
wherein a drive for rotation and a drive for axial movement of the conveying screw are synchronized to one another, taking into account at least one actual value each of the first and the further process parameters, such that a dosing of the predetermined dosed quantity, independent on dynamic superimpositions of the further process parameters, and simultaneous stopping of both drives at the end of the dosing procedure are performed, wherein the stopping of the two drives is initiated depending on the speed of return of the material and is synchronized, either in real time or at the start of the stopping procedure, with setpoint courses of the drives that are determined depending on the actual values, and wherein at least the setpoint curve of one of the two drives is variably adapted.
